(19) United States
(12) Patent Application Publication
(10) Pub. No.: US 2023/0297567 A1
(43) Pub. Date: Sep. 21, 2023

(54) INFORMATION PROCESSING SYSTEM, INFORMATION PROCESSING METHOD, AND NON-TRANSITORY RECORDING MEDIUM

(71) Applicant: Kenichi Tadokoro, Saitama (JP)

(72) Inventor: Kenichi Tadokoro, Saitama (JP)

(73) Assignee: Ricoh Company, Ltd., Tokyo (JP)

(21) Appl. No.: 18/178,022

(22) Filed: Mar. 3, 2023

(30) Foreign Application Priority Data
Mar. 17, 2022 (JP) 2022-042981
Nov. 30, 2022 (JP) 2022-191844

(51) Int. Cl. G06F 16/242; G06F 16/28

(52) U.S. Cl. CPC G06F 16/243; G06F 16/287

(57) ABSTRACT

An information processing system includes a memory that stores a database in which each of a plurality of applications is associated with pieces of information classified into a plurality of categories, and circuitry to extract one or more keywords, for each of the plurality of categories, from a search sentence and search the database for an application associated with information relating to the one or more keywords.

### CROSS-REFERENCE TO RELATED APPLICATIONS

This patent application is based on and claims priority pursuant to 35 U.S.C. § 119(a) to Japanese Patent Application Nos. 2022-042981, filed on Mar. 17, 2022 and 2022-191844, filed on Nov. 30, 2022, in the Japan Patent Office, the entire disclosure of which is hereby incorporated by reference herein.

### BACKGROUND

### Technical Field

The present disclosure relates to an information processing system, an information processing method, and a non-transitory recording medium.

### Related Art

With the development of information processing technology, the types of applications released to the market are increasing and the number of such applications is also enormous. For this reason, there are some techniques for appropriately proposing an application that meets the needs of a client.

For example, there is an image forming apparatus that includes a storage unit, a search unit, and a display control unit. The storage unit stores in advance a plurality of workflows formed of a combination of a plurality of predetermined processes among a plurality of processes of the image forming apparatus. The search unit searches for, when a process is selected and input, a workflow that includes the same process as the selected process from among the plurality of workflows stored in the storage unit. The display control unit controls a display unit to display an image representing the workflow extracted by the search unit as a search result. Accordingly, a workflow suitable for a user can be searched for and presented to the user.

### SUMMARY

In one aspect, an information processing system includes a memory that stores a database in which each of a plurality of applications is associated with pieces of information classified into a plurality of categories, and circuitry to extract one or more keywords, for each of the plurality of categories, from a search sentence and search the database for an application associated with information relating to the one or more keywords.

In another aspect, an information processing method includes extracting one or more keywords, for each of a plurality of categories, from a search sentence and searching a database for an application associated with information relating to the one or more keywords. The database in which each of a plurality of applications is associated with pieces of information classified into the plurality of categories.

In another aspect, a non-transitory recording medium storing a plurality of program codes which, when executed by one or more processors, causes the processors to perform a method. The method includes extracting one or more keywords, for each of a plurality of categories, from a search sentence and searching a database for an application associated with information relating to the one or more keywords. The database in which each of a plurality of applications is associated with pieces of information classified into the plurality of categories.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a hardware configuration of an entire system according to an embodiment of the present disclosure;

FIG. 2 is a block diagram illustrating an example of a hardware configuration of each of information processing apparatuses according to an embodiment of the present disclosure;

FIG. 3 is a block diagram illustrating functional units implemented by software included in the system according to an embodiment of the present disclosure;

FIG. 4 is a table illustrating an example of a database stored in an application database storage unit according to an embodiment of the present disclosure;

FIG. 5 is a flowchart illustrating an example of processing executed by the system to search for an application according to an embodiment of the present disclosure;

FIG. 6 is a diagram illustrating an example of a search screen to which a search sentence has not yet been input according to an embodiment of the present disclosure;

FIG. 7 is a diagram illustrating an example of the search screen presenting a search result according to an embodiment of the present disclosure;

FIG. 8 is a diagram illustrating a search screen according to a first modification of the embodiment of the present disclosure;

FIG. 9 is a diagram illustrating a search screen according to a second modification of the embodiment of the present disclosure;

FIG. 10 is a diagram illustrating a search screen according to a third modification of the embodiment of the present disclosure; and

FIG. 11 is a diagram illustrating a search screen according to a fourth modification of the embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The present disclosure is not limited to the embodiment described herein. In the drawings referred below, the same reference codes are used for the common elements, and the descriptions thereof are omitted as appropriate.

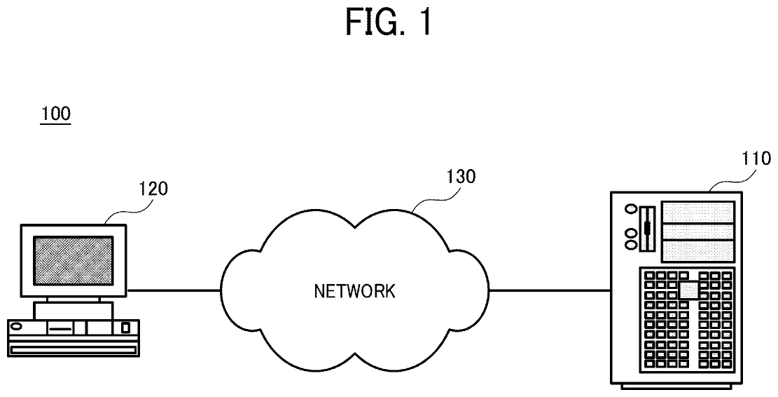

FIG. 1 is a schematic diagram illustrating a hardware configuration of an entire system of a system 100 according to the present embodiment. As illustrated in FIG. 1, for example, the system 100 according to the present embodiment is an information processing system including a server 110 and a terminal 120 that are connected via a network 130 such as the Internet or a local area network (LAN). The number of terminals 120 is not limited to that illustrated in FIG. 1, and the number of terminals 120 included in the system 100 is not limited. A method of connecting each of the server 110 and the terminal 120 to the network 130 may be wired or wireless.

The server 110 is an information processing apparatus that provides services according to the present embodiment. The server 110 according to the present embodiment searches for an application suitable for a client based on a search sentence input to the terminal 120, and responds to the terminal 120 with a search result.

The terminal 120 is an information processing apparatus operated by a user, and may be, for example, a personal computer, a smartphone terminal, or a tablet terminal. The terminal 120 according to the present embodiment transmits the search sentence input to the terminal 120 to the server 110 and displays the search result received from the server 110.

The embodiment described below is an example of a case where a sales representative of applications (user of the terminal 120) presents an application that solves an issue to a client who performs a certain operation or the like, but the embodiment is not particularly limited.

In the following description, the certain operation performed by the client is referred to as a “task.” However, the “task” does not necessarily have to be performed as a business, and may be performed for both commercial and non-commercial purposes. In other words, the “task” in the description of the present embodiment refers to a series of operations involving some process. Examples of the “task” are “print an invoice and bind the invoice in a file” and “write a date and time on a use schedule table of a conference room to make a reservation,” but these are merely examples and the embodiment is not limited. Further, in the description of the present embodiment, the “task” represents “applying a given ‘processing content’ to a ‘processing target’ so as to obtain a ‘processing result’.” For example, in the case of the task of “print an invoice and bind the invoice in a file,” the “invoice” represents the processing target, the “print” represents the processing content, and the “bind the invoice in a file” represents the processing result.

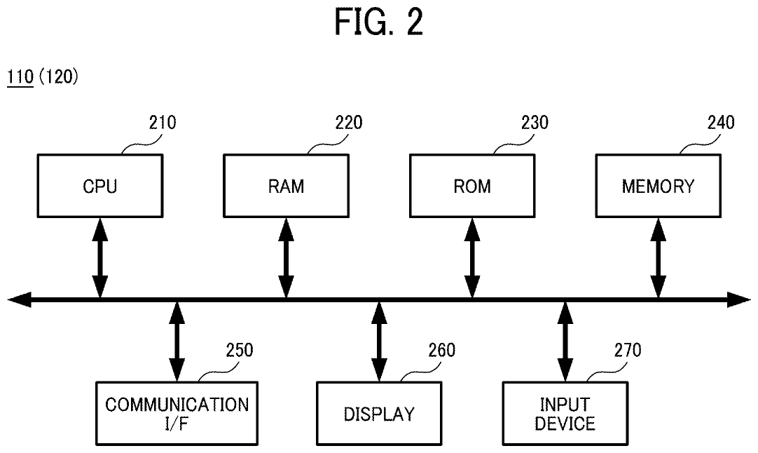

Next, a hardware configuration of each of apparatuses included in the system 100 according to the present embodiment is described. FIG. 2 is a block diagram illustrating an example of a hardware configuration of each of information processing apparatuses according to the present embodiment. The hardware configurations of the server 110 and the terminal 120 are substantially same. Each of the server 110 and the terminal 120 according to the present embodiment includes a central processing unit (CPU) 210, a random access memory (RAM) 220, a read only memory (ROM) 230, a memory 240, a communication interface (I/F) 250, a display 260, and an input device 270 that are connected to each other through a bus.

The CPU 210 is a device that executes programs to control operations of the server 110 and the terminal 120 to which the CPU 210 belongs, and perform given processing. The RAM 220 is a volatile memory for providing an execution space of a program executed by the CPU 210, and is used to store and expand programs and data. The ROM 230 is a non-volatile memory for storing such as programs and firmware to be executed by the CPU 210.

The memory 240 is a readable and writable non-volatile memory that stores operating system (OS) for operating the server 110 and the terminal 120 to which the memory 240 belongs, various kinds of software, setting information, and various kinds of data. Examples of the memory 240 include a hard disk drive (HDD) and a solid state drive (SSD).

The communication I/F 250 connects the server 110 and the terminal 120 to which the communication I/F 250 belongs with the network 130 to enable communication with other devices via the network 130. Communications via the network 130 may be either wired communications or wireless communications, and various kinds of data can be transmitted and received using a predetermined communication protocol such as a transmission control protocol/internet protocol (TCP/IP).

The display 260, which may be implemented by a liquid crystal display (LCD), displays various kinds of data, an operating state of the server 110 and the terminal 120 to which the display 260 belongs, and the like to the user. The input device 270, which may be implemented by a keyboard or a mouse, allows the user to operate the server 110 and the terminal 120 to which the input device 270 belongs. The display 260 and the input device 270 may be separate devices, or may be integrated into one device as in a case of a touch panel display.

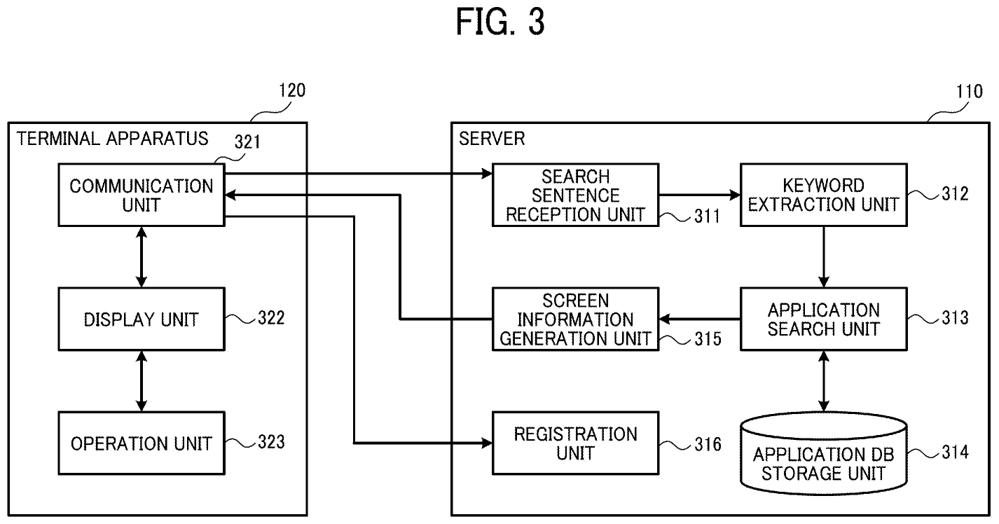

The hardware configurations of the server 110 and the terminal 120 according to the present embodiment have been described above. Next, functional units implemented by each hardware according to the present embodiment are described with reference to FIG. 3. FIG. 3 is a block diagram illustrating functional units implemented by software included in the system 100 according to the present embodiment.

The server 110 according to the present embodiment includes a search sentence reception unit 311, a keyword extraction unit 312, an application search unit 313, an application database storage unit 314, a screen information generation unit 315, and a registration unit 316. The terminal 120 according to the present embodiment includes a communication unit 321, a display unit 322, and an operation unit 323. Each of the functional units is described below in detail.

First, the server 110 is described. The search sentence reception unit 311 receives a search sentence input to the terminal 120 by communication via the communication I/F 250. The search sentence is information input by the user and is an example of input information.

The search sentence received by the search sentence reception unit 311 according to the present embodiment may be a natural sentence or one or a plurality of words. Further, the search sentence may be text data or audio data.

The keyword extraction unit 312 extracts one or more keywords from the search sentence received by the search sentence reception unit 311. A keyword according to the present embodiment is a single word included in the natural sentence or the plurality of words included in the search sentence. The keyword extraction unit 312 according to the present embodiment extracts, for example, a keyword representing a processing target related to the task (hereinafter referred to as a “processing target keyword”), a keyword representing a processing content related to the task (hereinafter referred to as a “processing content keyword”), and a keyword representing a processing result related to the task (hereinafter referred to as a “processing result keyword”) for individual categories.

The application search unit 313 searches the application database storage unit 314 for an application based on the one or more keywords extracted by the keyword extraction unit 312. The application search unit 313 according to the present embodiment compares the one or more extracted keywords with keywords that characterize applications stored in the application database storage unit 314 to specify an application that solves an issue on the task. The application search unit 313 transmits a search result to the screen information generation unit 315.

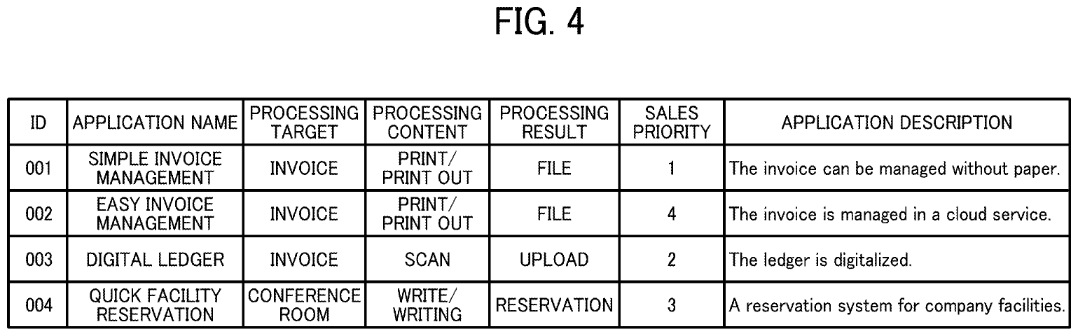

The application database storage unit 314 controls the memory 240 and stores information on the applications as a database. In response to a request from the terminal 120 of the application provider, the registration unit 316 registers, for each of a plurality of applications, the application and pieces of information to be stored, classified into a plurality of categories, in association with each other in the application database storage unit 314. The terminal 120 of the user who searches for an application may be different from the terminal 120 of the application provider in some cases. Next, an example of a database according to the present embodiment is described with reference to FIG. 4. FIG. 4 is a table illustrating an example of a database stored in the application database storage unit 314 according to the present embodiment.

As illustrated in FIG. 4, in the database according to the present embodiment, items such as an identifier (ID), a name, a processing target, a processing content, a processing result, a sales priority, and a description of an application are stored in association with each other. The form of the database illustrated in FIG. 4 is merely an example, and items other than those illustrated in FIG. 4 may be stored in the database.

The ID is a code for identifying an application in the database. The application name is a name of an application. In the example illustrated in FIG. 4, names of applications such as “SIMPLE INVOICE MANAGEMENT” and “EASY INVOICE MANAGEMENT” are stored. The processing target, the processing content, and the processing result are a target for, a content of, and a result of the processing executed by a corresponding application.

In a certain case, an application is a workflow application that executes a series of units of processing as a workflow including a combination of components that execute respective units of the processing. Examples of components include an input component that executes processing related to input, generation, or acquisition of data, a processing component that executes given processing such as processing or conversion of data, and an output component that executes processing related to output or transmission of data. An application may be formed of multiple input components, multiple processing components, and multiple output components. Also, an application may be formed of multiple applications.

The processing target is an example of input information. The input information is information related to the processing executed by the input component, and includes attribute information indicating an attribute of information on a target for the processing executed by an application or information on an input method indicating a method of acquiring the information on a target by the application. The attribute information is information indicating, for example, the type and extension of the information on a target or the name of the information on a target. The information on an input method includes information indicating, for example, an input method such as acquiring information by scanning a paper medium with an image forming apparatus, downloading information from an external apparatus such as a storage server, and receiving information by e-mail or facsimile, information for identifying an input device such as an image forming apparatus, and information for identifying an input service such as a storage server. The processing target may be a target of processing or operation substituted by the application. In this case, the input information is information related to the processing or operation substituted by the input component. For example, the input information is the attribute information indicating an attribute of the information on a target or the information on an input method indicating a method of acquiring the information on a target of the processing substituted by an application.

The processing content is an example of processing information. The processing information is information related to the processing executed by the processing component, and information related to the contents of one or more units of the processing executed by an application on the target indicated by the information on a target. For example, the processing information includes a type and setting information on various kinds of processing such as management of the information on a target, and processing on and conversion of the target indicated by the information on a target. The processing content may be contents of processing or operation substituted by the application. In this case, the processing information is information related to the processing or operation substituted by the processing component. For example, the processing information is the contents of the operation performed by the user or the contents of processing executed by another application or a device.

The processing result is an example of output information. The output information is information related to the processing executed by the output component, and includes attribute information indicating an attribute of information on a result of processing executed by an application or information on an output method indicating a method of outputting the information on the result by the application. The attribute information includes, for example, the type and extension of the information on a result, and the name of the information on a result. The information on an output method includes an output method such as outputting information by printing on a paper medium with an image forming apparatus, uploading information to an external apparatus such as a storage server, and transmitting information by e-mail or facsimile, information for identifying an output device such as an image forming apparatus, and information for identifying an output service such as a storage server. The processing result may be a result of processing or operation substituted by the application. In this case, the output information is information related to the processing or operation substituted by the output component. For example, the output information is the attribute information indicating an attribute of the information on a result of the processing or the information on an output method indicating a method of outputting the information on a result of the processing substituted by an application.

Hereinafter, information stored in the category of the processing target, information stored in the category of the processing content, and information stored in the category of the processing result in the database may be collectively referred to as stored information.

The sales priority represents the priority of an individual application for sales. For example, an application that has just been released can be given a higher priority. The description of an application is an item indicating the description of the characteristics of an application.

The application provider can register the various kinds of information described above in the database in advance via the registration unit 316. For example, the application provider can edit the database by accessing the server 110 via a device. At this time, the server 110 provides the device of the application provider with a user interface for editing the database. In the user interface, there are categories corresponding to the processing target, the processing content, and the processing result for individual applications. The application provider can register the information of an individual application for each category. At this time, the server 110 associates the information input as the processing target with the category of the processing target, associates the information input as the processing content with the category of the processing content, and associates the information input as the processing result with the category of the processing result, and stores the information in the database.

Returning to FIG. 3, the description continues. The screen information generation unit 315 generates information for displaying a screen of the user interface according to the present embodiment. The screen information generation unit 315 generates, for example, information for displaying an input screen related to a search for an application. For example, the input screen receives input of a keyword sentence. In addition, the screen information generation unit 315 receives a result of the search performed by the application search unit 313 and generates information for displaying a screen presenting the result of the search. The information for displaying a screen, generated by the screen information generation unit 315, is transmitted to the terminal 120 via the communication I/F 250. The information for displaying a screen of the user interface may be referred to as screen information. The screen information is described in Hyper Text Markup Language (HTML), Extended Markup Language (XML), Cascade Style Sheet (CSS), or JAVASCRIPT, for example.

Next, the terminal 120 is described. The communication unit 321 controls the communication I/F 250 to transmit and receive various kinds of data. The communication unit 321 according to the present embodiment, for example, transmits a search sentence input to the terminal 120 to the server 110 and receives screen information from the server 110.

The display unit 322 controls the display 260 and displays various kinds of user interfaces on a screen. The display unit 322 according to the present embodiment displays, for example, the search screen for searching for an application, the screen for presenting a search result, and the like.

The operation unit 323 receives an operation performed by the user via the input device 270. The operation unit 323 according to the present embodiment receives, for example, an operation to input characters with a keyboard or the like, an operation to input voice, an operation to designate a position with a pointing device, operations of various buttons, and the like.

The above-described functional units implemented by software correspond to functional units implemented by the CPU 210 executing programs according to the present embodiment to function each hardware. All the functional units described in the embodiment may be implemented by software, or a part or all of the functional units may be implemented as hardware providing equivalent functions.

All of the functional units described above do not necessarily have to be included in the configuration illustrated in FIG. 3. For example, in another preferred embodiment, each functional unit may be implemented by the server 110 and the terminal 120 that operate in cooperation.

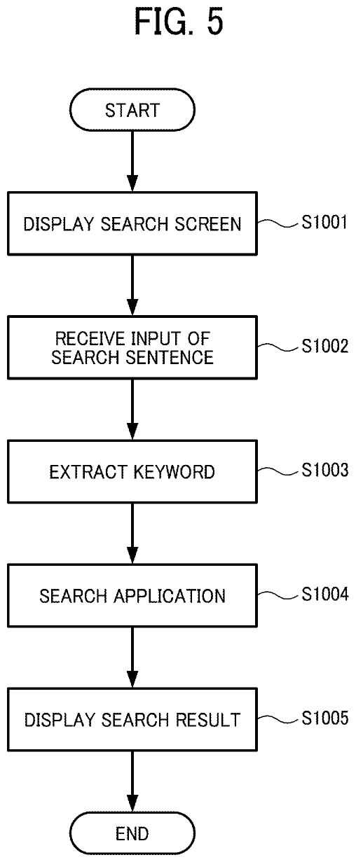

Next, processing to be executed by each of the above-described functional units is described with reference to FIG. 5. FIG. 5 is a flowchart illustrating an example of processing executed by the system 100 to search for an application according to the present embodiment. The system 100 starts the processing from step S1001.

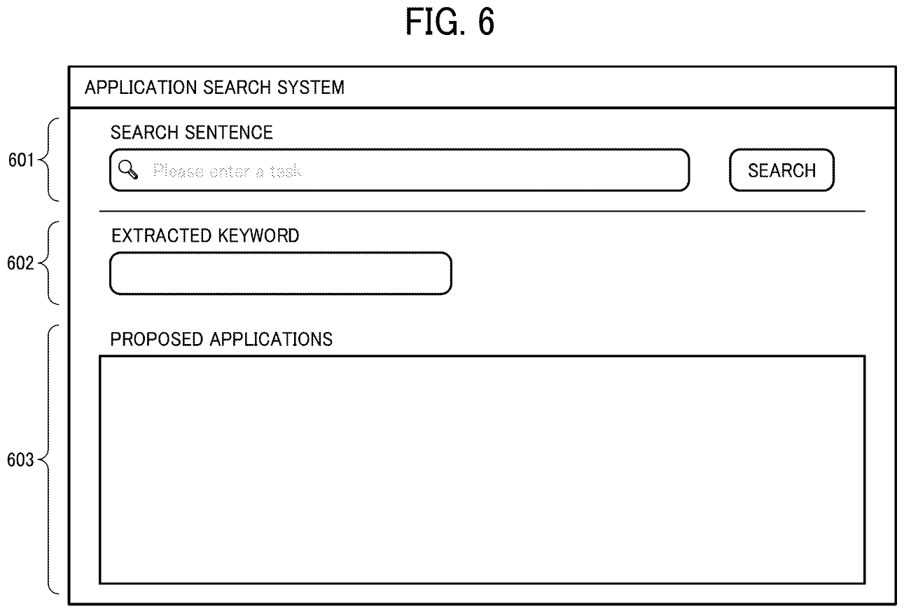

In step S1001, the terminal 120 receives the information for displaying a search screen from the screen information generation unit 315. The display unit 322 displays the search screen on the display 260. Here, an example of the search screen is described with reference to FIG. 6. FIG. 6 is a diagram illustrating an example of a search screen to which a search sentence has not yet been input according to the present embodiment.

As illustrated in FIG. 6, the search screen according to the present embodiment includes a search sentence input field 601, an extracted keyword display field 602, and a proposed application display field 603.

The search sentence input field 601 includes an input section for a search sentence and a search execution button. In the input section, a task including, for example, a processing target keyword, a processing content keyword, and a processing result keyword can be input in a natural sentence as a search sentence. As an example, a search can be performed by inputting “print an invoice and bind the invoice in a file.” Further, since there may be a case where an application can be specified by only a processing target keyword and a processing result keyword, in another preferred embodiment, a search may be performed by inputting a task including only the processing target keyword and the processing result keyword, such as “bind an invoice to a file.”

In the extracted keyword display field 602, one or more keywords extracted from the task input to the input section as a search sentence are displayed. In the proposed application display field 603, an application that the user proposes to the client is displayed as a result of the search performed based on the one or more keywords extracted from the task.

Returning to FIG. 5, the description continues. When the user inputs the search sentence on the search screen displayed in step S1001 as illustrated in FIG. 6 and presses the search execution button, the search sentence is transmitted to the server 110 via the communication unit 321 and is received by the search sentence reception unit 311 in step S1002.

Next, in step S1003, the keyword extraction unit 312 extracts one or more keywords from the search sentence input to the input section. For example, in a case where a task of “print an invoice and bind the invoice in a file” is input as a search sentence, the “invoice” is extracted as a processing target keyword, the “print” is extracted as a processing content keyword, and the “file” is extracted as a processing result keyword.

After the keywords are extracted in step S1003, the application search unit 313 searches the application database storage unit 314 based on the extracted keywords for an application that solves the issue related to the task in step S1004.

That is, the application search unit 313 searches for stored information that matches the processing target keyword in the category of the processing target in the database, searches for stored information that matches the processing content keyword in the category of the processing content in the database, and searches for stored information that matches the processing result keyword in the category of the processing result in the database. Thus, in a case where an application having pieces of stored information that match the keywords in all the categories in the database, the application search unit 313 specifies the application.

For example, assuming that the “invoice” is extracted as the processing target keyword, the “print” is extracted as the processing content keyword, and the “file” is extracted as the processing result keyword as described above, when the database illustrated in FIG. 4 is searched, applications associated with these keywords, such as the “SIMPLE INVOICE MANAGEMENT” having the ID of “001” and the “EASY INVOICE MANAGEMENT” having the ID of “002,” are specified. When a search is performed based on an extracted keyword, the search is performed to search for not only stored information that completely matches the keyword but also stored information that may not completely match the keyword taking ambiguity such as synonyms, similar words, and notation variations into account. The result of the search performed by the application search unit 313 is transmitted to the screen information generation unit 315. The result of the search may include not only an application having pieces of stored information that match the keywords in all the categories of the processing target, the processing content, and the processing result in the database as an application that satisfies all the conditions, but also an application having pieces of stored information that match the keywords in some categories as an application that satisfies some conditions.

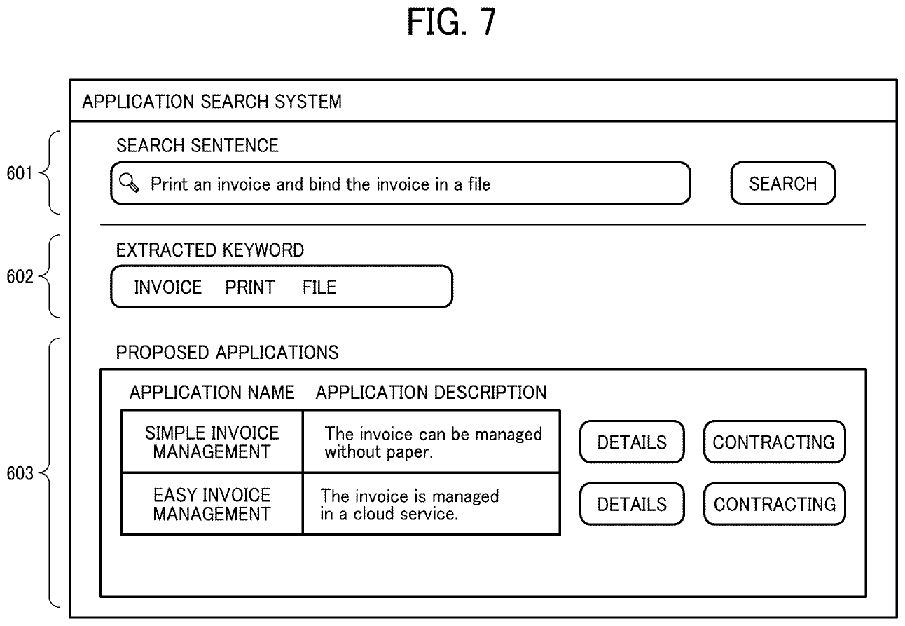

Next, the screen information generation unit 315 generates, based on the search result, screen information and transmits the screen information to be displayed to the terminal 120. The display unit 322 displays a screen presenting the search result on the display 260 based on the screen information in step S1005. An example of the screen displayed in step S1005 is described with reference to FIG. 7. FIG. 7 is a diagram illustrating an example of the search screen presenting a search result according to the present embodiment. The search screen illustrated in FIG. 7 is an example of a screen on which the processing of step S1004 illustrated in FIG. 4 is performed.

As illustrated in FIG. 7, on the search screen for displaying a search result, the keywords of “invoice,” “print,” and “file” are displayed in the extracted keyword display field 602 as extracted keywords. In the proposed application display field 603, each application of the “SIMPLE INVOICE MANAGEMENT” and the “EASY INVOICE MANAGEMENT” specified as applications to be proposed is displayed. Further, in the proposed application display field 603, a button for transitioning to a screen for displaying a description and details of each of the applications, and a button for transitioning to a screen for making a contract of each of the applications may be included. The user (for example, the sales representative of applications) can promote sales of the applications by presenting the search screen illustrated in FIG. 7 to the client. In particular, on the search screen illustrated in FIG. 7, the applications that solve the issue related to the task of the client are displayed as the search result. Thus, appropriate applications can be proposed, which easily leads to the purchase of the applications.

On the search screen for displaying a search result, in a case where applications that satisfy all the conditions and applications that satisfy some conditions are displayed, the applications that satisfy all the conditions are preferentially displayed. For example, the applications that satisfy all the conditions may be displayed side by side at the top of the proposed application display field 603, or may be highlighted by changing characters or colors or by adding a mark for distinguishing the applications that satisfy all the conditions from the applications that satisfy some conditions.

Returning to FIG. 5, the description continues. After the search result is displayed in step S1005, the system 100 ends the processing of searching for the applications.

Through the processing described above, the system 100 according to the present embodiment can search for an application that solves an issue related to a task. Thus, an appropriate application can be proposed to a client. This is advantageous over a technique of simply searching for a workflow that includes a process selected from a plurality of processes set in advance.

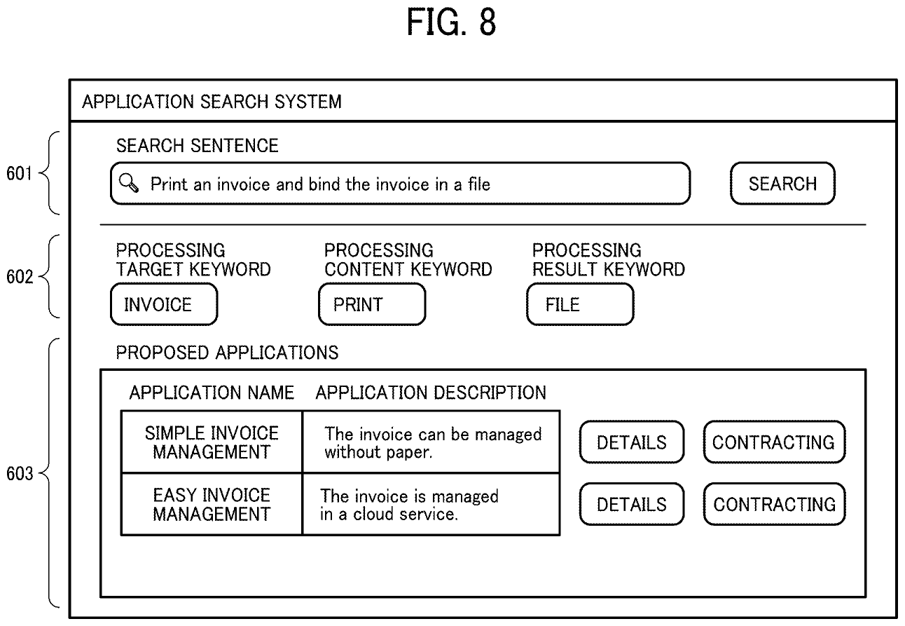

Although the basic configuration of the present embodiment has been described above, the above-described configuration is merely an example. The disclosure is not limited to the present embodiment. In particular, various modifications can be adopted for the search screen illustrated in FIGS. 6 and 7. Modifications of the search screen are described below with reference to FIGS. 8 to 11. FIGS. 8 to 11 are diagrams illustrating search screens according to first to fourth modifications of the embodiment, respectively.

Next, the first modification illustrated in FIG. 8 is described below. According to the first modification, the keywords displayed in the extracted keyword display field 602 are separately displayed as the processing target keyword, the processing content keyword, and the processing result keyword. Accordingly, the user can easily grasp how the keywords are extracted and how the applications are searched. Thus, a configuration that contributes to the proposal of a more appropriate application can be achieved. Also, in a case where any of the processing target keyword, the processing content keyword, or the processing result keyword is not appropriately extracted, the user can grasp that the extraction is not performed appropriately with the search screen illustrated in FIG. 8, and can take measures such as proposing another application. A configuration that allows the user to select and edit any one of the processing target keyword, the processing content keyword, and the processing result keyword displayed in the search screen may be adopted.

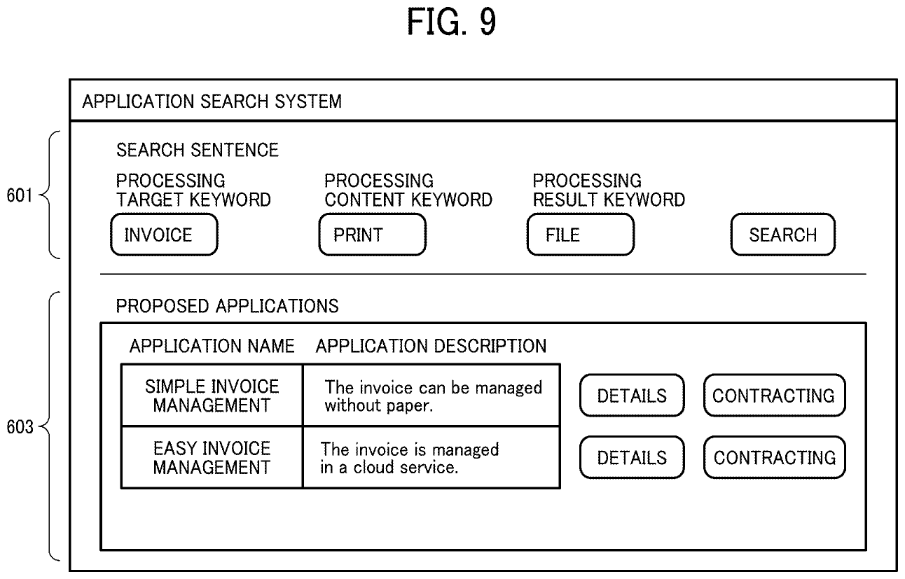

Next, the second modification of the embodiment illustrated in FIG. 9 is described. According to the second modification, the search sentence input field 601 is divided into sections of the processing target keyword, the processing content keyword, and the processing result keyword to be displayed. In other words, the keywords related to the task of the client are input by the user in the second modification. Thus, the accuracy of search can be independent of the accuracy of the processing of extracting the keywords, and applications can be searched for based on the appropriate keywords input by the user. As illustrated in FIG. 9, the search screen according to the second modification may be configured such that the extracted keyword display field 602 is omitted.

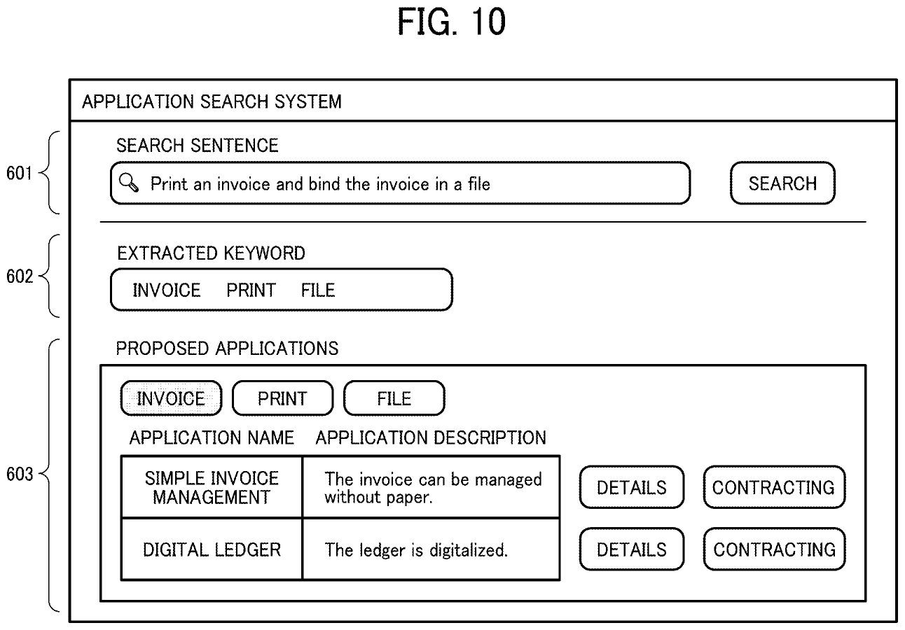

Next, the third modification of the embodiment illustrated in FIG. 10 is described. According to the third modification, buttons for selecting the extracted keywords are displayed in the proposed application display field 603. In other words, the buttons for selecting each of the keywords of “invoice,” “print,” and “file” are included in the proposed application display field 603 on the search screen of the third modification illustrated in FIG. 10. In the present modification, when a keyword is selected from the keywords in the buttons, an application can be searched for by weighting the selected keyword. In this case, not only applications having pieces of stored information that match the keywords in all the categories of the processing target, the processing content, and the processing result in the database are displayed as applications that satisfy all the conditions but also applications having a piece of stored information that matches the selected keyword may be displayed as applications that satisfy some conditions. Thus, the search for an application can be performed with the needs of the client being more accurately reflected.

Here, a description is given of an example case in which the “invoice” is selected as illustrated in FIG. 10 in the system 100 including the database illustrated in FIG. 4. In this case, the database illustrated in FIG. 4 includes three applications associated with the keyword of “invoice,” namely, applications having the IDs of “001” (“SIMPLE INVOICE MANAGEMENT”), “002” (“EASY INVOICE MANAGEMENT”), and “003” (“DIGITAL LEDGER”). Among these applications, the application having the ID of “002” is associated with the extracted keywords of “print” and “file,” but has a sales priority lower than those that the other applications have. On the other hand, the application having the ID of “003” is associated with the keyword of “invoice” and has a sales priority higher than that the application having the ID of “002” has. As a result, when the search is performed with the keyword of the “invoice” being weighted, the application of “DIGITAL LEDGER” having the ID of “003” is displayed as the proposed application as illustrated in FIG. 10.

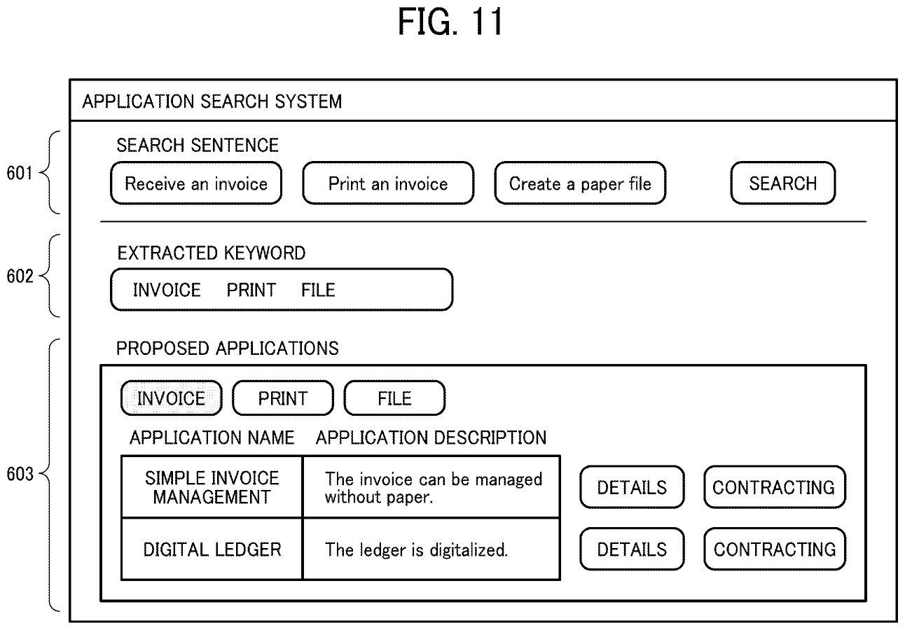

Next, the fourth modification of the embodiment illustrated in FIG. 11 is described. The fourth modification is common to the second modification in that three input fields are included in the search sentence input field 601. However, the keywords of the processing target, the processing content, and the processing result are input in the form of a sentence in the fourth modification, whereas those keywords are input as words in the second modification. In other words, as illustrated in FIG. 11, a search sentence of “Receive an invoice” is input as a processing target, a search sentence of “Print an invoice” is input as a processing content, and a search sentence of “Create a paper file” is input as a processing result. In some cases, a search sentence input as a processing target may be referred to as a processing target search sentence, a search sentence input as a processing content may be referred to as a processing content search sentence, and a search sentence input as a processing result may be referred to as a processing result search sentence. The keyword extraction unit 312 extracts a processing target keyword, a processing content keyword, and a processing result keyword from these search sentences. The application search unit 313 searches for applications to be proposed based on the keywords extracted by the keyword extraction unit 312. Accordingly, in the example of the fourth modification illustrated in FIG. 11, since a plurality of keywords of the “invoice” are input, a characteristic keyword related to a task can be easily extracted. Thus, a configuration that contributes to the proposal of a more appropriate application can be achieved. As illustrated in FIG. 11, a button for selecting a keyword to be weighted may be included in the proposed application display field 603 in the fourth modification as in the third modification.

Note that the basic configuration of the search screens of the present embodiment and the modifications illustrated in FIGS. 7 to 11 may be configured by combining respective features as long as there is no technical contradiction.

According to the above-described embodiment of the present disclosure, an information processing system, a processing method, and a non-transitory recording medium that allow searching for an appropriate application are provided.

Each of the functions of the above-described embodiment of the present disclosure can be implemented by a device-executable program written in, for example, C, C++, C #, and Java (registered trademark). The program according to the above-described embodiment of the present disclosure can be stored in a device-readable recording medium for distribution. Examples of the recording medium include a hard disk drive, a compact disk read only memory (CD-ROM), a magneto-optical disk (MO), a digital versatile disk (DVD), a flexible disk, an electrically erasable programmable read-only memory (EEPROM (registered trademark)), and an erasable programmable read-only memory (EPROM). The program can be transmitted over a network in a form with which another computer can execute the program.

Each of the functions of the above-described embodiment may be implemented by one or more processing circuits or circuitry. The “processing circuit or circuitry” in the present specification includes a programmed processor to execute each function by software, such as a processor implemented by an electronic circuit, and devices, such as an application specific integrated circuit (ASIC), a digital signal processor (DSP), a field programmable gate array (FPGA), and conventional circuit modules arranged to perform the recited functions. Although the embodiment of the present disclosure has been described above, embodiments of the present disclosure are not limited to the above-described embodiment, and various modifications may be made without departing from the spirit and scope of the present disclosure that can be estimated by skilled person. Such modifications exhibiting functions and effects of the present disclosure are included within the scope of the present disclosure.

For example, elements and/or features of different illustrative embodiments may be combined with each other and/or substituted for each other within the scope of the present invention. Any one of the above-described operations may be performed in various other ways, for example, in an order different from the one described above.

Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

In another aspect, an information processing apparatus includes a memory that stores a database in which each of a plurality of applications is associated with pieces of information classified into a plurality of categories, and circuitry to extract one or more keywords, for each of the plurality of categories, from a search sentence and search the database for an application associated with information relating to the one or more keywords.

1. An information processing system comprising:
a memory that stores a database in which each of a plurality of applications is associated with pieces of information classified into a plurality of categories; and
circuitry configured to:
extract one or more keywords, for each of the plurality of categories, from a search sentence; and
search the database for an application associated with information relating to the one or more keywords.

2. The information processing system according to claim 1, wherein the circuitry is further configured to register the applications and the pieces of information classified into the plurality of categories in the database in association with each other.

3. The information processing system according to claim 1, wherein the circuitry is further configured to receive an input of the search sentence and extract, from the search sentence, a processing target keyword and a processing result keyword related to a task.

4. The information processing system according to claim 3, wherein, one of the plurality of categories in the database is a category of a processing content, and
the circuitry is configured to:
extract, from the search sentence, a keyword including a processing content keyword related to the task; and
search the database for an application associated with a piece of information related to the processing content keyword in the category of the processing content.

5. The information processing system according to claim 3, wherein the circuitry is further configured to display, on a display, an input screen that receives the input of the search sentence, and a result of the search.

6. The information processing system according to claim 5, wherein the circuitry is configured to display, on the input screen, the processing target keyword and the processing result keyword.

7. The information processing system according to claim 6, wherein the input screen includes a section to which the processing target keyword is input and another section to which the processing result keyword is input.

8. The information processing system according to claim 7, wherein the circuitry is configured to receive the processing target keyword and the processing result keyword input in a form of a natural sentence.

9. The information processing system according to claim 3, wherein the circuitry is configured to display the search result and a keyword to be selected to be weighted in search processing.

10. An information processing method, the method comprising:
extracting one or more keywords, for each of a plurality of categories, from a search sentence; and
searching a database for an application associated with information relating to the one or more keywords, the database in which each of a plurality of applications is associated with pieces of information classified into the plurality of categories.

11. A non-transitory recording medium storing a plurality of program codes which, when executed by one or more processors, causes the processors to perform a method, the method comprising:
extracting one or more keywords, for each of a plurality of categories, from a search sentence; and
searching a database for an application associated with information relating to the one or more keywords, the database in which each of a plurality of applications is associated with pieces of information classified into the plurality of categories.
